(19) United States
(12) Patent Application Publication
(10) Pub. No.: US 2025/0258141 A1
(43) Pub. Date: Aug. 14, 2025

(54) SCREENING TOOL

(71) Applicant: Battelle Memorial Institute, Columbus, OH (US)

(72) Inventors: Wesley C. Pirkle, New Albany, OH (US); Richard L. Shoaf, Westerville, OH (US); Anthony Polinori, Powell, OH (US); John O'Brien, Worthington, OH (US); Timothy L. Cargol, McLean, VA (US); Eric G. Huckabee, McLean, VA (US); Leo S. Ludwick, McLean, VA (US); Trenton L. Good, Amanda, OH (US)

(21) Appl. No.: 19/054,132

(22) Filed: Feb. 14, 2025

Related U.S. Application Data
(60) Provisional application No. 63/553,411, filed on Feb. 14, 2024.

(51) Int. Cl. G01N 29/22; G01N 29/02

(52) U.S. Cl. CPC G01N 29/226; G01N 29/02; G01N 2291/022; G01N 2291/02881; G01N 2291/2695

(57) ABSTRACT

In one aspect, a screening tool for detecting whether a predetermined type of liquid is contained in a container includes a sensor arm subsystem in communication with a processing subsystem. The processing subsystem includes a processor disposed in a housing, an AC/DC converter electrically coupled to the processor, and ultrasonic components electrically coupled to the processor and the AC/DC converter. The sensor arm subsystem includes a sensor electrically coupled to the ultrasonic components, a temperature sensor electrically coupled to the processor, and an operator interface electrically couple to the processor.

### CROSS-REFERENCE TO RELATED APPLICATION

The present application claims the benefit of priority under 35 U.S.C. § 119 from U.S. Provisional Patent Application Ser. No. 63/553,411 entitled “Screening Tool,” filed on Feb. 14, 2024, the disclosure of which is hereby incorporated by reference in its entirety for all purposes.

### STATEMENT OF FEDERALLY FUNDED RESEARCH OR SPONSORSHIP

This invention was made with government support under contract FA864922P1165 awarded by the Air Force Research Laboratory. The government has certain rights in the invention.

### TECHNICAL FIELD

The present disclosure generally relates to sensors, and more specifically relates to a screening tool including an ultrasonic sensor for detection of liquids in containers.

### BACKGROUND

Liquids can be transported in containers of various sizes ranging from water bottles to fuel tanks. Under certain scenarios, such as for security purposes, it is necessary to detect the type of liquid in the container. As such, there is a desire for a screening tool that can detect a type of liquid in a non-invasive and time efficient manner.

The description provided in the background section should not be assumed to be prior art merely because it is mentioned in or associated with the background section. The background section may include information that describes one or more aspects of the subject technology.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is a perspective view of a screening tool positioned for screening a tank containing liquid according to certain aspects of the disclosure.

FIG. 2 is a perspective front view of a processing subsystem of the screening tool of FIG. 1, according to certain aspects of the disclosure.

FIG. 3 is a perspective rear view of the processing subsystem of the screening tool of FIG. 1, according to certain aspects of the disclosure.

FIG. 4 is a side view of the processing subsystem of the screening tool of FIG. 1, according to certain aspects of the disclosure.

FIG. 5 is a front view of the processing subsystem of the screening tool of FIG. 1, according to certain aspects of the disclosure.

FIG. 6 is a top perspective view of the processing subsystem of the screening tool of FIG. 1 with a top removed, according to certain aspects of the disclosure.

FIG. 7 is a top view of the processing subsystem of the screening tool of FIG. 1 with the top removed, according to certain aspects of the disclosure.

FIG. 8 is a perspective view of a sensor arm subsystem of the screening tool of FIG. 1, according to certain aspects of the disclosure.

FIG. 9 is a front view of the sensor arm subsystem of the screening tool of FIG. 1, according to certain aspects of the disclosure.

FIG. 10 is a side view of the sensor arm subsystem of the screening tool of FIG. 1, according to certain aspects of the disclosure.

FIG. 11 schematically illustrates the interconnections of the screening tool of FIG. 1, according to certain aspects of the disclosure.

FIG. 12 is a front view of an interface of the sensor arm subsystem of the screening tool of FIG. 1, according to certain aspects of the disclosure.

FIG. 13 illustrates an example process for determining status states of the screening tool.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

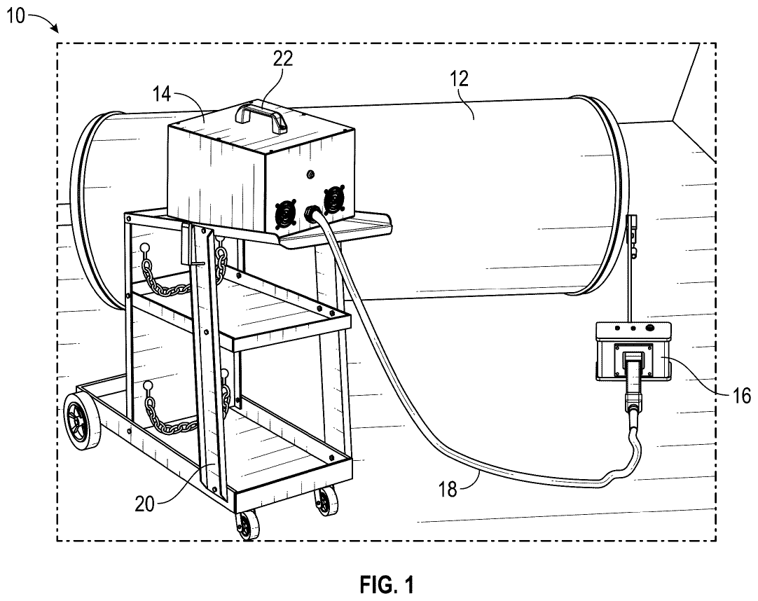

FIG. 1 depicts an environment in which a screening tool 10 can be useful. As is illustrated, the screening tool 10 is positioned for screening a container 12, which contains a liquid. It should be understood that the screening tool 10 is not necessarily illustrated to scale with respect to the container 12. The screening tool 10 includes a processing subsystem 14 and a sensor arm subsystem 16. The processing subsystem 14 is in communication with the sensor arm subsystem 16 via a cable 18. In the embodiment illustrated in FIG. 1, the cable 18 serves as a method of communication between the processing subsystem 14 and the sensor arm subsystem 16; however, in other embodiments, other communication methods or protocols can be incorporated into the screening tool 10. For example, the components of the screening tool 10 can be arranged to communicate through other methods or protocols, such as, for example, GSM (Global System for Mobile Communications), Short Message Service (SMS), Enhanced Messaging Service (EMS), or Multimedia Messaging Service (MMS) messaging, CDMA (Code Division Multiple Access), Time division multiple access (TDMA), Personal Digital Cellular (PDC), Wideband CDMA, General Packet Radio Service (GPRS), or LTE (Long-Term Evolution), Bluetooth protocols, Wi-Fi networks, RFID technology, and other appropriate communication methods and protocols. As will be described in more detail below, the screening tool 10 is configured to perform non-invasive inspections of containers, such as the container 12, to detect whether a predetermined type of liquid is contained in the container 12. In certain aspects, the container 12 is a fuel tank on a vehicle.

The screening tool 10 is portable and includes a handle 22 mounted on the processing subsystem 14 for carrying. In certain aspects, the screening tool 10 can be transported on a cart 20. While the cart 20 illustrated in FIG. 1 is a readily accessible utility cart 20, in certain embodiments the cart can be a customized cart built specifically to transport the screening tool 10 and/or the processing subsystem 14.

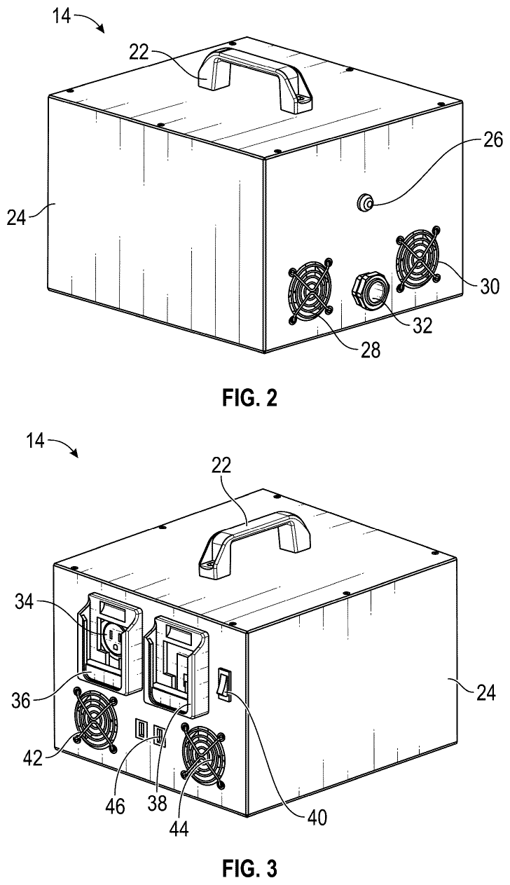

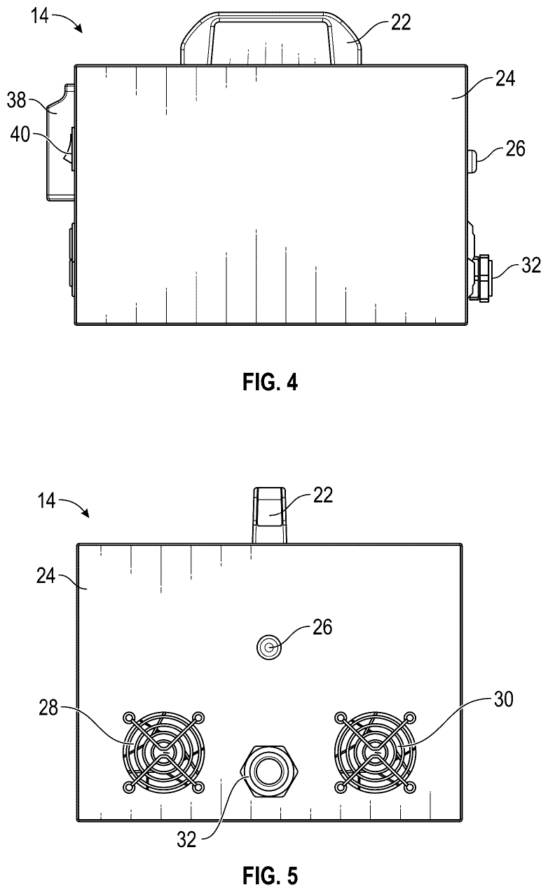

Referring to FIGS. 2-7, the processing subsystem 14 of the screening tool 10 includes a housing 24. The housing 24 can be substantially rectangular in shape, but other shapes are well within the scope of the present disclosure. The handle 22 is affixed to the top of the housing 24 and is configured to allow a user to carry the processing subsystem 14. Disposed on the front of the housing 24 of the processing subsystem 14 are a power button 26, a first front fan grill 28, a second front fan grill 30, and a first cable strain relief 32. The first cable strain relief 32 is configured to receive and support the cable 18. Disposed on the rear of the housing 24 of the processing subsystem 14 are a power receptacle 34, a first battery mount 36, a second battery mount 38, a power switch 40, a first rear fan grill 42, a second rear fan grill 44, and a pair of data ports 46. The processing subsystem 14 is illustrated with a pair of data ports 46; however, in other embodiments, the pair of data ports can be a single data port or three or more data ports depending on the intended implementation of the screening tool 10 and other factors. The power receptacle 34 can be, but is not limited to, an AC power receptacle. The screening tool 10 can be either powered with AC power by connecting a power cord (not illustrated) to the power receptacle 34 or by rechargeable batteries (not shown), which can be secured in the first battery mount 36 and/or the second battery mount 38 during use. When AC power is selected for use, the rechargeable battery would be unsecured from the first battery mount 36 to allow access to the power receptacle 34. In certain aspects, the power consumption of the screening tool 10 is approximately 50 watts (“W”). The data ports 46 can be any appropriate data port including, but not limited to, USB ports and other appropriate ports. The data ports 46 are configured for receiving various devices such as, but not limited to, a USB hub, a monitor, a mouse, a keyboard, a USB drive to enable data downloads, and other appropriate devices. In certain aspects, the approximate weight of the processing subsystem 14 is 15 lbs.

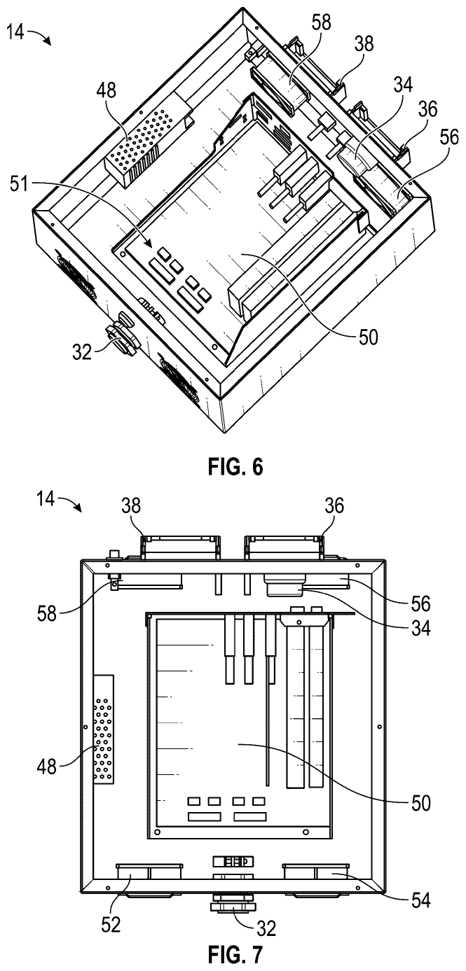

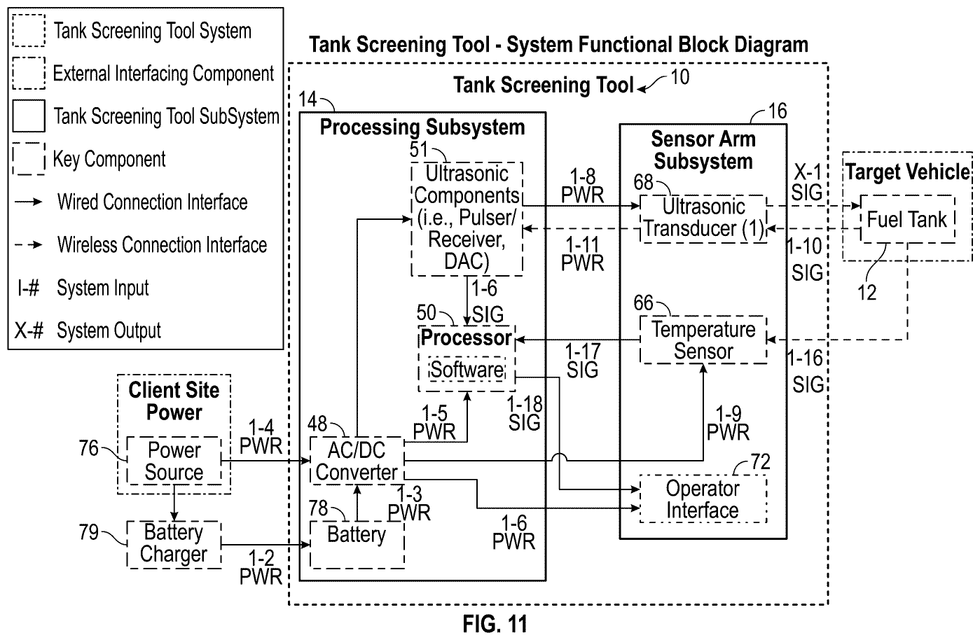

With particular reference to FIGS. 6-7 where the top of the housing 24 is removed to reveal components positioned inside the housing 24, an interior of the processing subsystem 14 includes a power converter 48 (e.g., AC/DC converter), a processor 50 in communication with, and electrically coupled to, ultrasonic components 51 (e.g., pulser/receiver, digital to analog converter (ADC), which are schematically illustrated in FIG. 11, a first front fan 52, a second front fan 54, a first rear fan 56, and a second rear fan 58. The first front fan 52 is positioned adjacent to the first front fan grill 28. The second front fan 54 is positioned adjacent to the second front fan grill 30. The first rear fan 56 is positioned adjacent to the first rear fan grill 42. The second rear fan 58 is positioned adjacent to the second rear fan grill 44. The first front fan 52, the second front fan 54, the first rear fan 56, and the second rear fan 58 are collectively configured to cool the interior of the processing subsystem 14 to facilitate effective operation of the processing subsystem 14. The processor 50 is configured to detect a previously selected liquid such as, but not limited to, diesel based on ultrasonic wavelength data received from the sensor arm subsystem 16 and characterized across environmental conditions for the previously selected liquid. The processor 50 is configured to control and communicate with the sensor arm subsystem 16, as described in more detail below. In certain aspects, the processor 50 is electrically couple to the pair of data ports 46 for receiving and transmitting signals to various devices inserted into the pair of data ports 46. For example, in certain aspects, a data port of the pair of data ports 46 is a USB port configured to enable data downloads to an inserted USB drive.

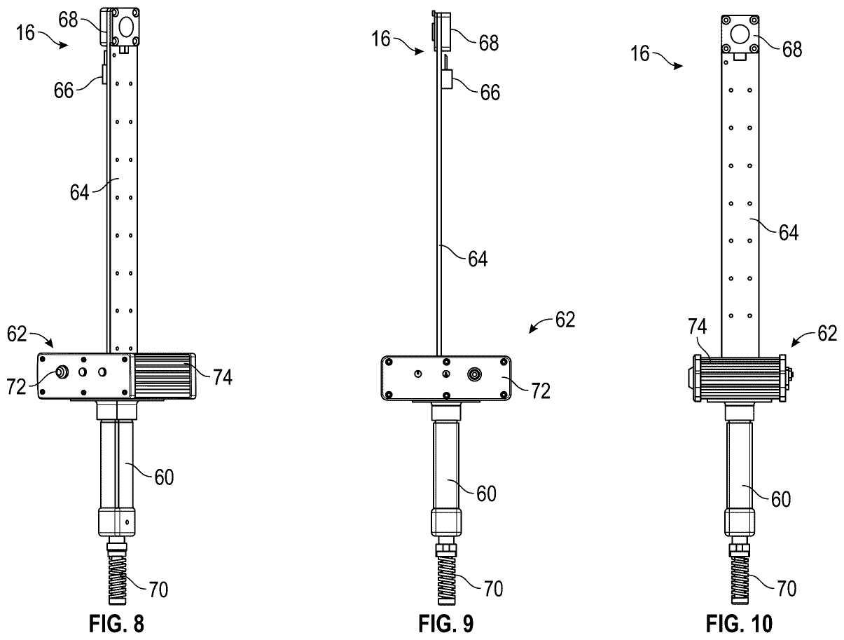

Moving to FIGS. 8-10, the sensor arm subsystem 16 includes a handgrip 60, a case 62, an arm 64, a temperature sensor 66, and a sensor 68. One side of the case 62 is coupled to the handgrip 60 while the arm 64 extends from the other opposite side of the case 62. The temperature sensor 66 can be, but is not limited to, a thermocouple, a thermistor, a resistance temperature detector, a semiconductor-based sensor, and other appropriate sensors capable of reading temperature. The temperature sensor 66 and the sensor 68 are attached to a distal end of the arm 64. A second cable strain relief 70 is coupled to the handgrip 60 and is configured to receive and support the cable 18. An operator interface 72 is coupled to the exterior of the case 62. In certain aspects, a speaker 74 is coupled to the case 62. The speaker 74 is configured to provide an audio alert when the processor 50 makes certain determinations such as, but not limited to, when presence of a substance other than the previously selected liquid is detected. In certain aspects, the sensor 68 is an ultrasonic sensor configured to send and receive ultrasonic pulses.

With reference to FIG. 11, in certain aspects, the cable 18 sheaths a plurality of wires for connecting components of the processing subsystem 14 to components of the sensor arm subsystem 16. For example, a first wire electrically couples the ultrasonic components 51 to the sensor 68, a second wire electrically couples the processor 50 to the temperature sensor 66, a third wire electrically couples the power converter 48 to the temperature sensor 66, a fourth wire electrically couples the power converter 48 to the operator interface 72, and a fifth wire electrically couples the processor 50 to the operator interface 72. In certain aspects, a sixth wire electrically couples the processor 50 to the speaker 74. As previously noted, while the embodiment illustrated and described includes wired communication, other embodiments of a screening tool can include various methods of wireless communication.

With further reference to FIG. 11, the power converter 48 is electrically coupled to, and in communication with, a number of other components to provide wired power such as the processor 50, the ultrasonic components 51, the temperature sensor 66, and the operator interface 72. The power converter 48 receives wired power from a power source 76 via the power receptacle 34 and from at least one battery 78, which can be rechargeable by the power source 76 via a charger 79. In certain aspects, the power converter 48 can either receive wired power from the power source 76 via the power receptacle 34 or from the at least one battery 78. The at least one battery 78 can be mounted to the first and second battery mount 36, 38. The processor 50 is directly or indirectly in communication with, and electrically coupled to, a number of components such as the ultrasonic components 51 to receive wired signals therefrom, the temperature sensor 66 to receive wired signals therefrom, the operator interface 72 to deliver wired signals thereto, and the power converter 48 to receive wired power therefrom. The ultrasonic components 51 are directly or indirectly in communication with, and electrically coupled to, a number of components such as the sensor 68 to receive wireless signals therefrom and to deliver wired power thereto, the processor 50 to deliver wire signals thereto, and the power converter 48 to receive wired power therefrom.

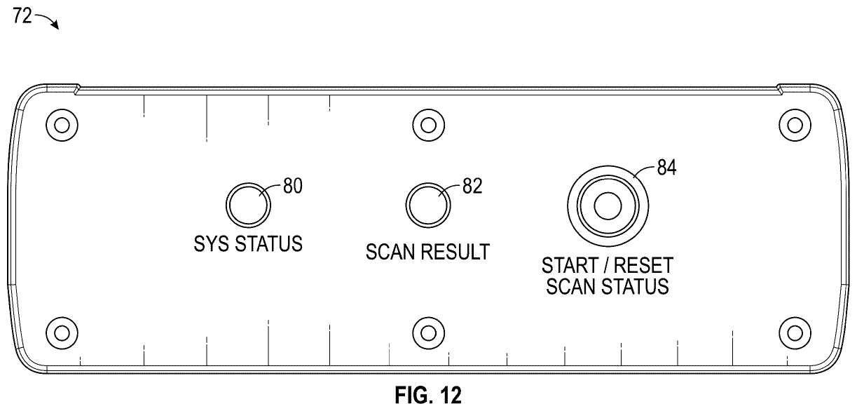

As depicted in FIG. 12, the operator interface 72 of the sensor arm subsystem 16 includes a first indicator 80, a second indicator 82, and a button indicator 84. The first indicator 80 is configured to indicate system status of the screening tool 10 with various lighting for different status. For example, the first indicator 80 can be unlit to indicate that the system status is “off,” can be lit with a first color (such as, but not limited to, green) to indicate that the system status is “system ready to scan,” and can be lit with a second color (such as, but not limited to, red) to indicate that the system status is “system not ready for scan.” The second indicator 82 is configured to indicate scan result status of the screening tool 10 with various lighting for different status. For example, the second indicator 82 can be unlit to indicate that the scan result status is “off,” can be lit with a first color (such as, but not limited to, green) to indicate that the scan made a positive detection of a previously selected liquid, and the scan result status can be lit with a second color (such as, but not limited to, red) to indicate that the scan detected a presence of a substance other than the previously selected liquid. The button indicator 84 is a combination button and indicator. The button of the button indicator 84 is configured to, responsive to engaging the button, start or reset the scan. The indicator of the button indicator 84 is configured to indicate scan status of the screening tool 10 with various lighting for different status. For example, the indicator of the button indicator 84 can be unlit to indicate that the scan status is “off,” can be lit with a first color (such as, but not limited to, green) to indicate a successful scan, can be lit with a flashing first color to indicate that the scan status is in progress, can be lit with a second color (such as, but not limited to, red) to indicate an unsuccessful scan, and can be lit with a flashing second color to indicate that the scan status is in a self-test. The button indicator 84 is strategically positioned on the operator interface 72 such that a user can maintain constant contact with the handgrip 60.

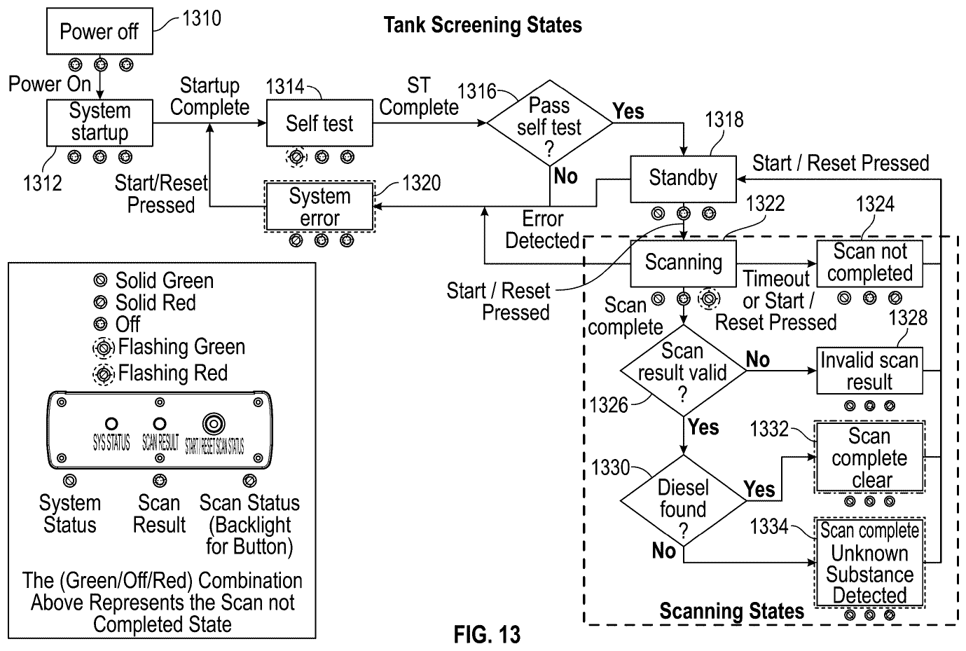

FIG. 13 illustrates a flow chart of an example process for determining status states of the first indicator 80, the second indicator 82, and the button indicator 84. As depicted at step 1310, the screening tool 10 is powered off and the first indicator 80, the second indicator 82, and the button indicator 84 are all unlit. When the screening tool 10 is powered on, as illustrated at step 1312, the processor 50 enters system startup and the first indicator 80, the second indicator 82, and the button indicator 84 all remain unlit. After the startup is completed, the processor 50 runs a self-test, as illustrated at step 1314, and the button indicator 84 is lit with the flashing second color to indicate that the scan status is in the self-test while the first indicator 80 and the second indicator 82 remain unlit. The processor 50 determines at step 1316 whether the self-test passes. When the processor 50 determines that the self-test passed the screening tool 10 proceeds to standby, as depicted at step 1318, and the first indicator 80 is lit with the first color to indicate that the system status is “system ready to scan” while the second indicator 82 and the button indicator 84 remain unlit. On the other hand, when the processor 50 determines that the self-test has not passed, as depicted at step 1320, the first indicator 80 is lit with the second color to indicate that the system status is “system not ready for scan” while the second indicator 82 and the button indicator 84 remain unlit. While not illustrated, the foregoing combinations can be documented either in a manual or on the sensing tool 10 to assist an operator who is operating the sensing tool 10.

As illustrated at step 1322, responsive to the button of the button indicator 84 being engaged, the processor 50 begins the scanning process such that the first indicator 80 is lit with the first color to indicate that the system status is “system ready to scan,” the button indicator 84 is lit with the flashing first color to indicate that the scan status is in progress, and the second indicator 82 is unlit. When the processor 50 determines that the scan has timed out or the button of the button indicator 84 has been engaged during the scanning process, as depicted at step 1324, the processor 50 stops the scanning process and changes the indicator of the button indicator 84 to be lit with the second color to indicate an unsuccessful scan while the first indicator 80 remains lit with the first color to indicate that the system status is “system ready for scan” and the second indicator 82 remains unlit. If the button of the button indicator 84 is engaged again after step 1324, then the process proceeds to step 1318.

After step 1322 when the scan is completed, the processor 50 determines whether the scan result is valid, as depicted at step 1326. When the processor 50 determines that the scan result is not valid, as depicted at step 1328, the first indicator 80 remains lit with the first color to indicate that the system status is “system ready for scan,” the second indicator 82 will remain unlit, and the button indicator 84 will be lit with the second color to indicate an unsuccessful scan. If the button of the button indicator 84 is engaged again after step 1328, then the process with proceed to step 1318. When the processor 50 instead determines that the scan result is valid at step 1326 the processor 50 then determines whether the previously selected liquid is detected, as depicted at step 1330. When the processor 50 determines that the previously selected liquid is detected, as illustrated at step 1332, the first indicator 80 remains lit with the first color to indicate that the system status is “system ready for scan,” the second indicator 82 will be lit with the first color to indicate that the scan made a positive detection of the previously selected liquid, and the button indicator 84 will be lit with the first color to indicate the successful scan. If the button of the button indicator 84 is engaged again after step 1332, then the process proceeds to step 1318.

When the processor 50 determines that the previously selected liquid is not detected at step 1330 the processor 50 completes the scan and indicates that an unknown substance is detected, as illustrated at step 1334, such that the first indicator 80 remains lit with the first color to indicate that the system status is “system ready for scan,” the second indicator 82 is lit with the first color to indicate that the scan detected a presence of a substance other than the previously selected liquid, and the button indicator 84 is lit with the second color to indicate that the scan was successfully completed.

In operation, the power button 26 and the power switch 40 are engaged to power on the screening tool 10. Once powered on, the processor 50 will conduct the self test. After the processor 50 determines that the self test passed, a user of the screening tool 10 can position the sensor 68 of sensor arm subsystem 16 proximate the container 12. Preferably, the sensor 68 is positioned at an end of the container 12 such that the sensor 68 sends ultrasonic pulses through the end and length of the container 12 and receives echoes of the pulses that bounce off the other end of the container 12. With the sensor 68 of the sensor arm subsystem 16 properly placed proximate the end of the container 12, the user can engage the button of the button indicator 84 to initiate the scan. During the scan, the sensor 68 sends ultrasonic pulses through the end and length of the container 12 and receives the echo of the pulses that bounce off the other end of the container 12. The sensor 68 then sends the received echo pulses to the ultrasonic components 51, which sends them to the processor 50 to determine whether the scan result is valid and whether the previously selected liquid is detected.

While not illustrated, the foregoing combinations can be documented either in a manual or on the sensing tool 10 to assist an operator who is operating the sensing tool 10.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A screening tool for detecting whether a predetermined type of liquid is contained in a container, the screening tool comprising:
a processing subsystem comprising
a housing,
a processor disposed in the housing,
an AC/DC converter electrically coupled to the processor,
ultrasonic components electrically coupled to the processor and the AC/DC converter; and
a sensor arm subsystem in communication with the processing subsystem, the sensor arm subsystem comprising
a sensor electrically coupled to the ultrasonic components,
a temperature sensor electrically coupled to the processor,
an operator interface electrically coupled to the processor.

2. The screening tool of claim 1, wherein the sensor is an ultrasonic sensor configured to send and receive ultrasonic pulses.

3. The screening tool of claim 1, wherein the temperature sensor is one of a thermocouple, a thermistor, a resistance temperature detector, and a semiconductor-based sensor.

4. The screening tool of claim 1, wherein the sensor arm subsystem further comprises
a case, wherein the operator interface is coupled to the case,
a handgrip coupled to the case,
an arm extending from the case, wherein the sensor and the temperature sensor are attached to a distal end of the arm.

5. The screening tool of claim 1, wherein the operator interface comprises a first indicator, a second indicator, and a button indicator.

6. The screening tool of claim 1, wherein the processing subsystem further comprises
a pair of data ports electrically coupled to the processor, wherein the pair of data ports are configured to enable data downloads.

7. The screening tool of claim 1, wherein the processing subsystem further comprises
at least one front fan grill disposed on a front of the housing,
at least one rear fan grill disposed on a rear of the housing, and
at least one battery mount disposed on the rear of the housing.

8. The screening tool of claim 7, wherein the processing subsystem further comprises
at least one front fan positioned adjacent to the at least one front fan grill, and
at least one rear fan positioned adjacent to the at least one rear fan grill.

9. The screening tool of claim 1, wherein the ultrasonic components of the processing subsystem further comprises a pulser/receiver and a digital to analog converter.

10. The screening tool of claim 1, wherein the processing subsystem further comprises a handle affixed to a top of the housing.

11. A processing subsystem for detecting whether a predetermined type of liquid is contained in a container, the processing subsystem comprising:
a housing;
a processor disposed in the housing, wherein the processor is electrically couplable to a screening tool;
an AC/DC converter electrically coupled to the processor; and
ultrasonic components electrically coupled to the processor and the AC/DC converter.

12. The processing subsystem of claim 11, further comprising a pair of data ports electrically coupled to the processor, wherein the pair of data ports are configured to enable data downloads.

13. The processing subsystem of claim 11, further comprising
at least one front fan grill disposed on a front of the housing,
at least one first rear fan grill disposed on a rear of the housing, and
at least one battery mount disposed on the rear of the housing.

14. The processing subsystem of claim 13, further comprising
at least a first front fan positioned adjacent to the at least one front fan grill, and
at least a first rear fan positioned adjacent to the at least one rear fan grill.

15. The processing subsystem of claim 11, wherein the ultrasonic components further comprise a pulser/receiver and a digital to analog converter.

16. A sensor arm subsystem for detecting whether a predetermined type of liquid is contained in a container, the sensor arm subsystem comprising:
a case;
a handgrip coupled to the case;
an arm extending from the case;
an ultrasonic sensor attached to a distal end of the arm, wherein the ultrasonic sensor is configured to send and receive ultrasonic pulses, wherein the ultrasonic sensor is electrically couplable to a processing subsystem;
a temperature sensor attached to the distal end of the arm; and
an operator interface coupled to the case.

17. The sensor arm subsystem of claim 16, wherein the temperature sensor is one of a thermocouple, a thermistor, a resistance temperature detector, and a semiconductor-based sensor.

18. The sensor arm subsystem of claim 16, wherein the operator interface comprises a first indicator, a second indicator, and a button indicator.

19. The sensor arm subsystem of claim 16, wherein the temperature sensor is electrically couplable to a processor of the processing subsystem.

20. The sensor arm subsystem of claim 19, wherein the operator interface is electrically couplable to the process of the processing subsystem.
